(19) United States
(12) Patent Application Publication
(10) Pub. No.: US 2006/0135997 A1
(43) Pub. Date: Jun. 22, 2006

(54) Peek a boo pacifier

(76) Inventor: Agustin Carmona, Miami, FL (US)

Correspondence Address: Agustin Carmona;8TH LANE, 12914 N.W., Miami, FL, 33182, US

(21) Appl. No.: 11/016,592

(22) Filed: Dec. 20, 2004

(51) Int. Cl. A61J 17/00

(52) U.S. Cl. 606/234

(57) ABSTRACT

An improved pacifier having a thin housing frame (10) made of a durable material. A nipple (12) made of a flexible, rubbery material, with a breathing hole at its top, a stem, and a hallow bulb ending. And a pair of thin cover guards (14) with teeth at its ends and concaves at their centers and made of a durable material.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to infants and small children, specifically to an improved pacifier.

2. Discussion of Prior Art

Originally, pacifiers were made with an exposed nipple. Which in the case of an infant dropping or throwing the pacifier on the ground.

The pacifier will get dirty and collect bacteria. The infant will then pick it up and stick it back in his or her mouth. Transferring the dirt and bacteria into his or her body via the mouth. Or mothers will pick it up stick it in their mouths cleaning it off with their saliva. Transferring the bacteria from their mouths to their childs mouths.

### OBJECTS AND ADVANTAGES

Accordingly, several objects and advantages of my invention are:

a. to provide a device which can be produced in a variety of colors.

b. to provide a device which is both flexible and durable.

c. to provide a device that protects itself, to prevent it from getting dirty or collecting bacteria.

d. to provide a device that can be used by infants and children of most ages.

### SUMMARY

In accordance with the present invention, the device comprises a housing frame, a nipple, and a pair of cover guards.

### DRAWINGS

FIG. 1 is a fully assembled view of my invention.

FIG. 2 is a back view of my invention.

FIG. 3 is a front view of my invention.

FIG. 4 is a perspective exploded view of my invention.

FIGS. 5 thru 7 are operational views of my invention.

FIG. 8 is an internal view of my invention.

### List of Reference Numerals

10 Housing Frame
12 Nipple
14 Cover Guard

### DETAILED DESCRIPTION

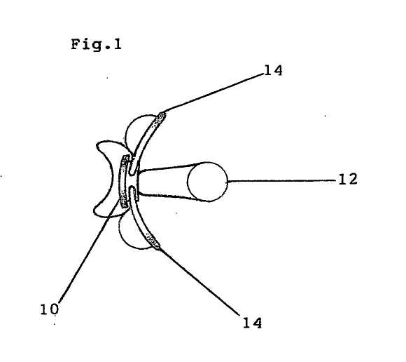

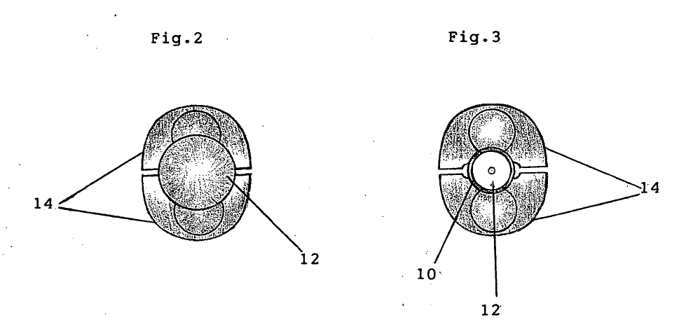

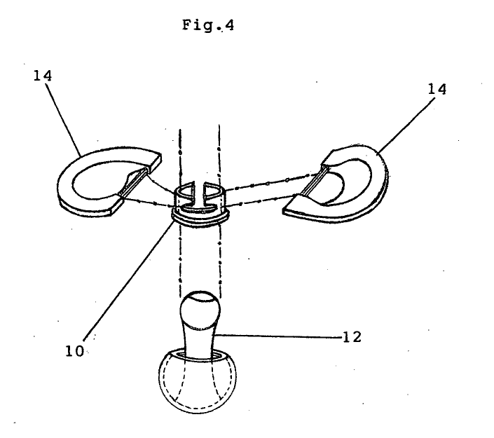

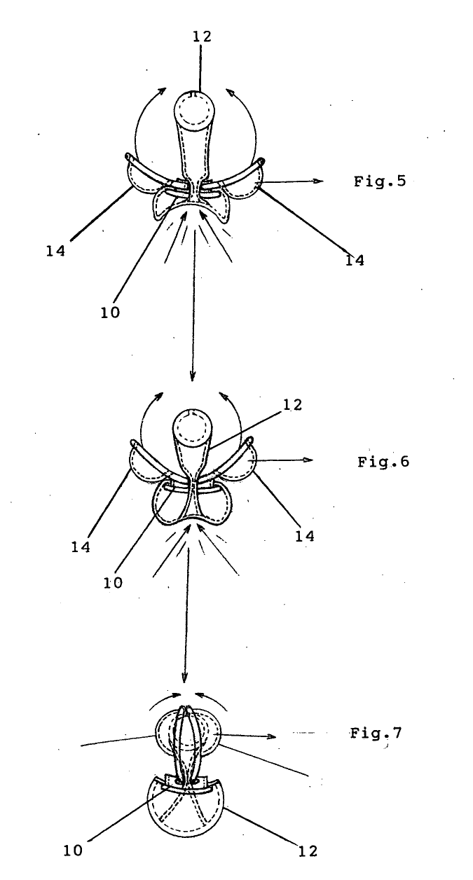

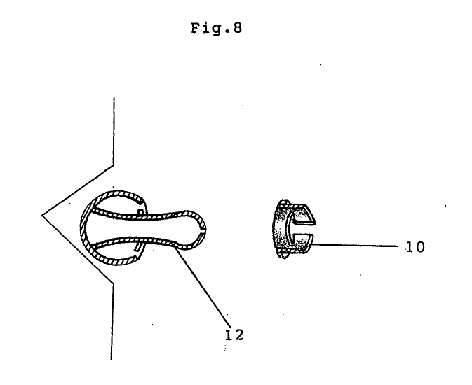

### Preferred Embodiment—FIGS. 1 and 4

A preferred embodiment of the present invention is illustrated in FIG. 1 (Fully assembled). The invention has a thin durable housing frame 10 consisting of a beveled base. The base has a circular openning running through it. The body of the housing frame 10 is cylindrical in shape. With a square cutout at its sides ending in an oval cutout.

A set of cover guards 14 are inserted onto the oval cutouts of the housing frame 10, as illustrated in FIG. 4 (prospective exploded view). The cover guards 14 are thin and made of a durable material. Are unshaped with a concaved center. At its ends is a toothed rod.

A nipple 12 is inserted through the bottom of the housing frame 10 and is attached to the beveled end of the housing frame's 10 base. The nipple 12 is made of an elastic or rubbery material. Has a hallow bulbous housing with an openning at its top. Protruding from the inner bottom center of the bulbous frame is a suckable stem like nipple, with a rounded out top. The rounded out top is hallow and seperate from the stem, with a breathing hole to its top.

### Operation of Invention—FIGS. 5 thru 7

The manner of using this invention is similar to that of pacifiers in present use. Namely, one first pushes up from the bottom of the nipple 12 as illustrated in (FIG. 6).

In deing so, the stem pushes against the teeth of the cover guards 14. Openning them up as illustrated in (FIG. 5). Next, holding the nipple in, it is placed into the childs mouth. The cover guards 14 fit the contour of the childs face. As the child sucks on the nipple 12 it maintains the pacifier locked in that position.

Upon the child taking it out, spitting it out, it falling out etc. The pressure is released on the nipple 12 it snaps back into its starting position as illustrated in (FIG. 7). While snapping back, the stem of the nipple 12 pushes onto the teeth of the cover guards 14. Closing the cover guards 14 over the nipple 12. Preventing it from collecting dust, bacteria, etc.

### Conclusion, Ramifications, and Scope of Invention

Thus the reader will see that the Peek A Boo Pacifier provides a highly reliable, lightweight, yet economical device that can be used by infants and children of almost any age. Prevents the child or infant from becoming in contact orally from germs, bacteria, and grime. Through the use of the cover guards. Accordingly, the scope of the invention should not be determined by the embodiments illustrated, but by the appended claims and their legal equivalents.

I claim:

1. A device comprising:
a. a body housing having cutout notches to house theirin a pair of protectors and a nipple,
b. said nipple mounted in said body housing for pacifying, and
c. means for controllably covering said nipple with said protectors from grime, bacteria etc,
whereby said device will pacify a child and protect from said grime, bacteria, etc.
